(19) United States
(12) Patent Application Publication
(10) Pub. No.: US 2007/0288283 A1
(43) Pub. Date: Dec. 13, 2007

(54) METHOD FOR PROJECT MANAGEMENT

(75) Inventor: Craig Fitzpatrick, Ottawa (CA)

Correspondence Address: VINCENT PATENT AGENCY, 11-300 EARL GREY DRIVE, SUITE 202, KANATA, ON, K2T 1C1, US

(73) Assignee: DEVSHOP INC., Ottawa (CA)

(21) Appl. No.: 11/759,917

(22) Filed: Jun. 7, 2007

Related U.S. Application Data
(60) Provisional application No. 60/812,644, filed on Jun. 9, 2006.

(51) Int. Cl. G06F 9/46

(52) U.S. Cl. 705/8

(57) ABSTRACT

A method for project management that can be used to achieve a more accurate project schedule at the beginning of, and during the life of a project. The method can be built into a software product, or used manually.

The method uses data collection, modeling, analysis, reporting and visualization to reduce the impact of risk in project scheduling and thereby improve the project's chances of a successful outcome (e.g. as measured by stronger adherence to: budget, deadline, quality and specifications).

The method introduces time estimation error, distraction rate and schedule confidence into the project schedule and provides for visualization of the schedule in the form of Gantt charts in difference views organization by component, by team member and by project.

### CROSS-REFERENCE TO RELATED APPLICATIONS

This application claims priority from U.S. Provisional Patent Application Ser. No. 60/812,644, filed Jun. 9, 2006, the entirety of which is incorporated herein by reference.

### FIELD OF INVENTION

The present invention relates to the field of project management. In particular, to a method for project management.

### BACKGROUND

Project management methodologies, processes and tools have existed for many years. The discipline has evolved based upon a fundamental principle: that the same methodologies, processes and tools work for all kinds of projects. This principle has served a purpose in the past, in that it has allowed for the development of a common set of basic processes and terminology that project managers can use regardless of the kind of project they are running.

However, in particular fields of work, the basic processes, methodologies and tools are failing to provide a consistent level of success in the projects to which they are applied. In particular, it is commonly held that approximately 70% of software projects are considered failures, on average, globally. A failure in this context is defined as a project that was significantly challenged in one or more of the following dimensions: budget, deadline, quality and meeting specifications.

Today, software development projects have permeated almost every kind of modern business. From pure software companies, to government organizations, to airlines and grocery stores, most modern organizations of mid-size or greater produce some kind of software. Our economy has evolved to the point of nearly demanding that businesses produce or use some kind of software, just to keep up with the rest of the world, and to survive.

Despite constant innovation in the general field of software development, software projects are becoming more (not less) complex. With larger team sizes, more requirements and more sophistication, software projects are becoming increasingly difficult to manage to a specific timeline, budget and acceptable level of quality.

A project is comprised of many work items (called tasks) which may or may not be specifically assigned to a team member. The schedule includes all tasks for the project.

Most formally managed projects include a person (project manager) who is responsible for creating and organizing the project schedule either in isolation, or by collaborating with the project team.

One of the key management tools used by the manager or team is the Gantt chart. A Gantt chart is a particular visualization of a project or schedule. It reads left-to-right, top-to-bottom, where the work tasks that need to be performed are listed top-to-bottom (on the left of the page), and a box is drawn on the diagram to the right of the task list, to illustrate the relative size (i.e. duration) and position (i.e. start date) of the task relative to other tasks. FIG. 4 is a schematic representation of an exemplary Gantt chart 100 illustrating task 120 in a project 110 including tasks 120 that roll up into a task group 130. Larger tasks 120 have larger (i.e. longer) bars, and tasks 120 that start sooner are positioned closer to the left-hand-side of the diagram.

Modern Gantt chart tools include the ability to create dependencies or constraints, which provide data to schedule recalculation algorithms. A dependency is a situation where one task is forced to wait until another task has been completed before it may begin. Creating many dependencies to ensure that a set of tasks are performed one after another (in order) is referred to as sequencing or serializing those tasks.

The Gantt chart is typically created near the beginning of a project (or before the project officially begins) and is manually updated throughout the life of the project. The Gantt chart is a list of tasks and a visual representation of the schedule.

What is needed is a method of project management that can address the issues with current project management approaches described above.

### SUMMARY OF INVENTION

A method for project management that can be used to achieve a more accurate project schedule at the beginning of, and during the life of a project. The method can be built into a software product, or used manually.

The method uses data collection, modeling, analysis, reporting and visualization to reduce the impact of risk in project scheduling and thereby improve the project's chances of a successful outcome (e.g. as measured by stronger adherence to: budget, deadline, quality and specifications).

In one aspect the method includes the observation, analysis and characterization of project team member attributes relating to performance, project scheduling and risk.

Another aspect of the method provides for an iterative improvement to the project success rate by pulling historical data forward from past projects and automatically injecting the “lessons learned” from past projects into future project plans.

Another aspect of the method also provides for “in-progress” improvements to the realism of the project plan, by performing real-time analysis on collected data to allow for the team to course-correct mid-project.

In accordance with one aspect of the present invention, there is provided a method for project management by adding risk-based adjustments to a schedule for a project, the project having a plurality of tasks, each task having an estimated duration and one or more dependencies on other tasks, the project further having one of a plurality of team members assigned for executing each of the tasks and a project store for storing the task estimated duration, dependency and team member information for each task, the method comprising the steps of: collecting all of the tasks in the project; collecting, for each task, all of the predecessor tasks from which the task has a dependency; adding to the collected predecessor tasks, for each predecessor task, any other predecessor tasks from which the predecessor task has dependencies until all predecessor tasks have been collected; adding a risk-based adjustment to the finish date of each of the collected predecessor tasks, the risk-based adjustment comprising: a distraction rate for the team member assigned to predecessor task; and a time estimation error rate for the team member assigned to the predecessor task; and rescheduling each of the tasks in the project to start on the business day after the latest finish date of any of the predecessor tasks of the task.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1A is a schematic representation of a traditional approach to estimating task duration.

FIG. 1B is a schematic representation of an approach to estimating task duration including risk-based factors in accordance with a method of the present invention.

FIG. 2A is a schematic representation of a traditional approach to scheduling sequential tasks based on the estimated task durations.

FIG. 2B is a schematic representation of an approach to scheduling sequential tasks including risk-based factors in accordance with a method of the present invention.

FIG. 3A is a schematic representation of a plurality of sequential tasks having explicit dependencies.

FIG. 3B is a schematic representation of a plurality of sequential tasks sequenced using implicit dependencies derived from alternatively a task-group and a team member's priorities.

FIG. 4 is a schematic representation of an exemplary Gantt chart including tasks that roll up into a task group.

FIG. 5A is a schematic representation of a Gantt chart in which tasks are organized under nodes representing team members to which the tasks are assigned.

FIG. 5B is a schematic representation of a Gantt chart in which tasks are organized under nodes representing projects to which the tasks belong.

FIG. 6 is a schematic representation of meta-data associated with a task.

FIG. 7 is a schematic representation of tasks illustrating both explicit and implicit distractions.

FIGS. 8A-B are schematic representations of tasks illustrating direct and indirect circular references respectively.

FIG. 9 is a flow diagram representing the steps for calculating a distraction rate.

FIG. 10 is a flow diagram representing the steps for calculating a time estimation error.

FIG. 11 is a flow diagram representing the steps for calculating schedule confidence.

FIG. 12 is a flow diagram representing the steps for risk based scheduling.

FIG. 13 is a flow diagram representing the steps for detecting and storing circular references.

### DETAILED DESCRIPTION

A method for project management that can be used to achieve a more accurate project schedule at the beginning of, and during the life of a project. The method comprises: changes to the current approaches to project management; new additions to the current approaches to project management; several new metric definitions, calculations and processes; and several new visualizations of project data.

### Implicit Dependencies

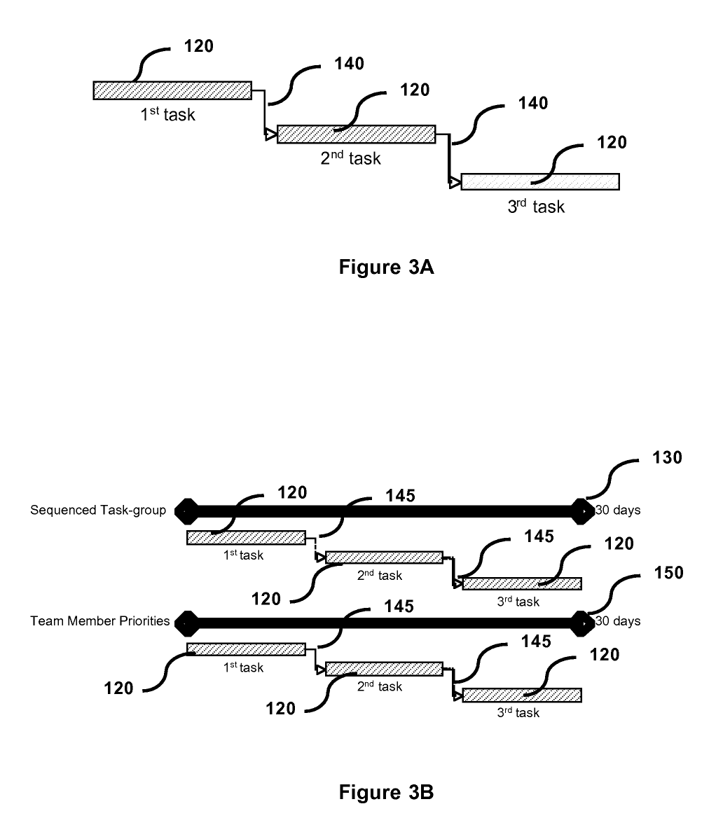

FIG. 3A is a schematic representation of a plurality of sequential tasks 120 having explicit dependencies 140. In existing project management tools, the activity of sequencing or serializing tasks 120 is accomplished by manually creating dependencies, so that each task 120 must wait for its predecessor to be completed before it may begin. Typically, this is accomplished by specifying a numeric task ID of the predecessor task (i.e. the task that must finish first) as meta-data for the dependent task 120 (i.e. the task that must wait). This is a time consuming and error prone process, as looking up and inputting numeric IDs is an unnatural way for humans to interact with a model. In addition, it is error prone because an erroneous ID can be entered and not noticed immediately, causing dramatic inaccuracies in the resulting schedule. Manually entered dependencies run the risk of creating circular reference loops. A circular reference is a situation where a first task must wait on another task, but that task must also wait on the first task. This situation creates an impossible schedule and can cause a project management computer program to enter into an endless execution loop. Most project management applications are programmed to prevent the user from entering data that would create a circular reference. However, the more manually entered dependencies the user creates in a schedule, the more likely it is to result in dependencies that are not allowed to be created because they result in circular references.

The method for projection management provides a new construct called an implicit dependency. FIG. 3B is a schematic representation of a plurality of sequential tasks 120 sequenced using implicit dependencies 145 derived from alternatively a task-group 130 and a team member's priorities. Unlike an explicit (i.e. manually entered) dependency 140, an implicit dependency 145 is one that is inferred based upon some other meta-data or relationship the tasks 120 have. For example, the method provides for a new piece of metadata that can be attached to a task-group 130, called sequencing. If two or more tasks 120 belong to a task-group 130 that is sequenced, then all tasks 120 within the task-group 130 have inferred dependencies, such that they will be automatically scheduled in the order they appear in the Gantt chart, one after another. Another embodiment of implicit dependencies is a result of task assignment. The method provides for a process whereby any tasks 120 that are directly assigned to a team member 150 are automatically considered to have implicit dependencies, such that each assigned task 120 must be scheduled in the order of priority (i.e. the natural order that the tasks 120 are assigned to the team member).

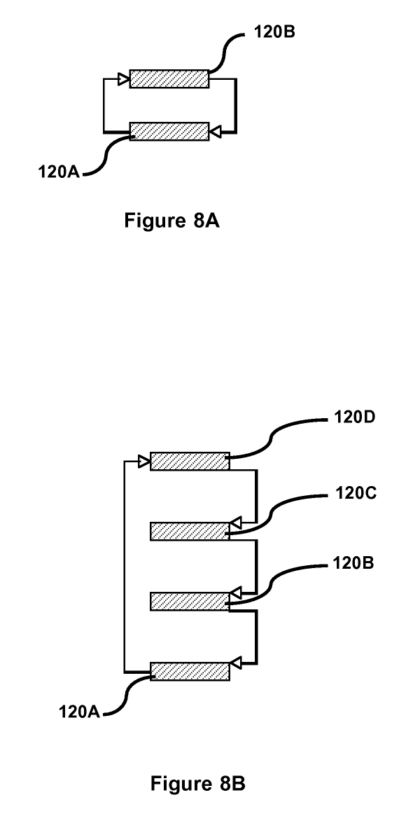

The method also provides a process for detecting and reporting on the causes of circular references, beyond direct dependencies. FIGS. 8A-B are schematic representations of tasks illustrating direct and indirect circular references respectively. A direct circular reference is one where Task A 120A is dependent on Task B 120B but Task B 120B is also directly dependent on Task A 120A. An indirect circular reference is one where Task A 120A is dependent on Task B 120B but Task B 120B is dependent on one or more other tasks (e.g. 120C, 120D) that are dependent on Task A 120A (i.e. there are more than two tasks in the loop). While current tools are able to detect a possible indirect circular reference in order to prevent them, they typically cannot detect or report on the chain of causes for that indirect circular reference. For example, current tools may report that Task A 120A cannot be dependent on Task B 120B because Task B 120B is directly or indirectly dependent on Task A, but they cannot detect or report that there are, for example, seven distinct reasons (i.e. causes) why that dependency would fail. It is this level of transparency and reporting to the user that gives the user the knowledge required to make adjustments to the dependencies such that they can fit the new dependency they are trying to create into the existing schedule.

Detecting the causes of indirect circular references is done in the following manner. Before Task A can be made to be dependent on Task B, a collection of all tasks that Task A is directly dependent on is generated. The collection is expanded recursively so that for every item in the collection, its direct dependencies are also added, until there are no other direct dependencies found for every task in the collection. With this collection of tasks that Task A is dependent on, the system creates a collection of schedule assertions to test and to capture failures. An assertion is a rule that describes this task must come before that task. The assertions are individually tested by checking if a given task is already dependent on another given task (and would create a circular reference). If so, a schedule assertion conflict is generated, and a list of conflicts is kept. A schedule assertion conflict is a description of why a schedule assertion can not succeed. It includes a reference to the two tasks tested, as well as a reason for the failure. The reasons for a schedule assertion conflict include, for example: the tasks are already dependent in the way tested; the tasks are already dependent in the reverse way (would create a circular reference), and if there is an existing dependency between the tasks, what kind of dependency it was: manual (explicit) or some kind of implicit (task group sequencing or task assignment). Once the collection of conflicts is collected, they may be reported to the user. An example of the reporting of a single conflict may be: “Task A could not be scheduled before Task B because Task A and Task B are assigned to Suzy Queue and Task B is a higher priority.”

In some cases, attempting to create a new dependency will generate a long list of schedule assertion conflicts, each describing to the user one reason why the dependency cannot be created. Each conflict can be a result of a direct, indirect, explicit or implicit dependency that already exists between the two tasks.

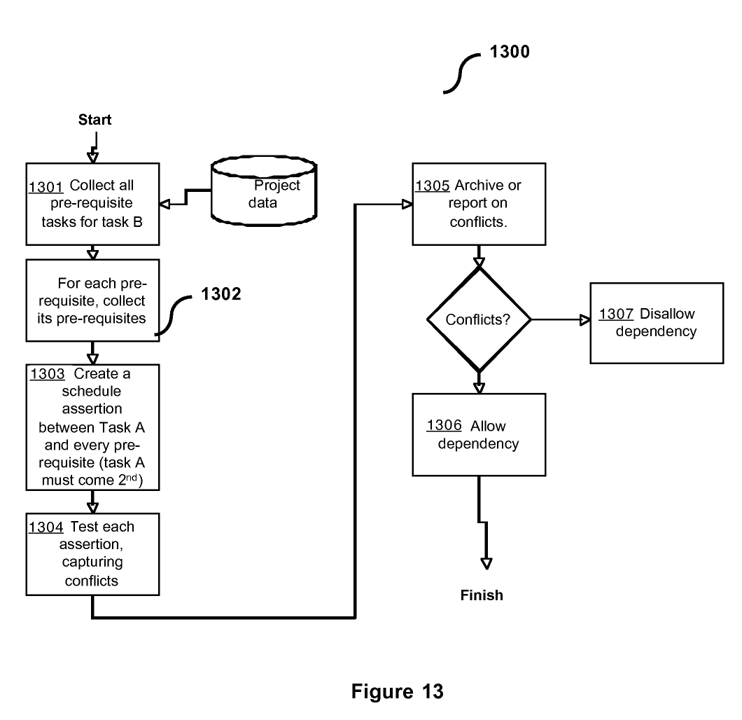

FIG. 13 is a flow diagram representing the steps 1300 for detecting and recording circular references both direct and indirect. In the illustrated example, Task A is being made to depend on Task B.

In step 1301 all of the prerequisite (predecessor) tasks for Task B are collected.

In step 1302, for each prerequisite task, its prerequisites are collected in a recursive function.

In step 1303, a set of schedule assertions is created such that each prerequisite must come before Task A.

In step 1304, each assertion is tested and any resulting conflict is recorded. Testing an assertion means to test if the task that must come first is already dependent (directly or indirectly) on the task that must come last. If so, that is a conflict and is recorded.

In step 1305, the conflicts are archived for future use and/or the conflicts are reported directly.

In step 1306, if there were no conflicts, the dependency is created.

In step 1307, if there were conflicts, the dependency is disallowed.

### Visualization

In practice, project managers typically structure their Gantt charts to reflect the set of requirements for their project, as moving requirements into tasks in the schedule is typically the first step in creating a schedule. However, this view becomes near useless for the activity of scheduling (i.e. resourcing) that the project manager needs to do every day after the first schedule is built, until the end of the project.

The method according to the present invention provides for splitting the Gantt chart into distinct views including:

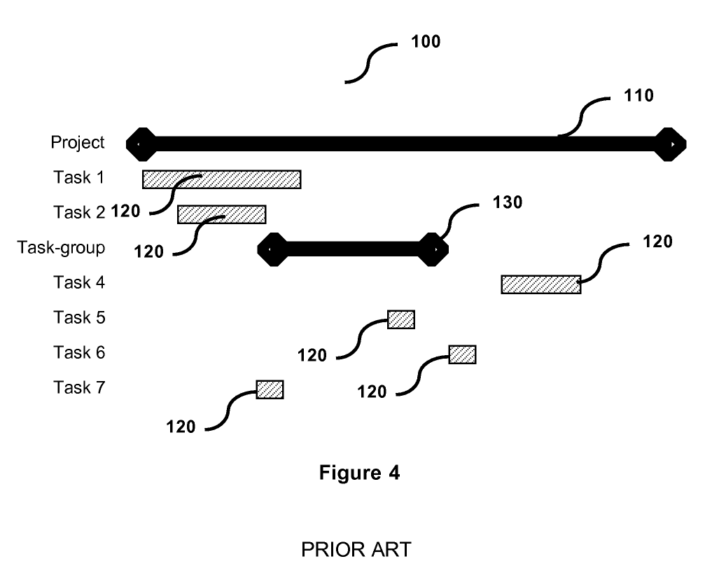

Schedule by Component: FIG. 4 is a schematic representation of an exemplary Gantt chart 100 including a schedule by component view. This view visualizes tasks 120 as they roll up into task-groups 130 and ultimately into a single project 110. The schedule by component view can be used to match the requirements list to the schedule to ensure that they are synchronized. Tasks 120 are not necessarily serialized.

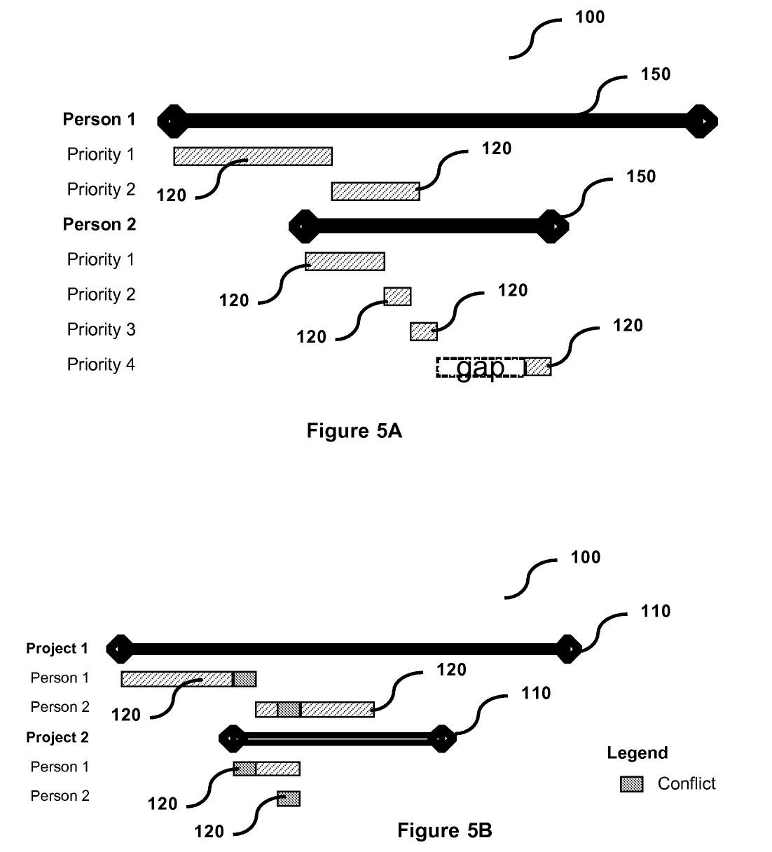

Schedule by Person: FIG. 5A is a schematic representation of a Gantt chart 100 in which tasks 120 are organized under nodes representing team members 150 to which the tasks 120 are assigned. This view visualizes the tasks 120 as they roll up for each team member 150 (that the tasks 120 are assigned to) and ultimately into a single project (not illustrated). The schedule by person view can be used to quickly scan and detect productivity gaps and/or bottlenecks across the team. Tasks are serialized to occur one-after-another, by each team member 150.

Schedule by Project: FIG. 5B is a schematic representation of a Gantt chart 100 in which tasks 120 are organized under nodes representing projects 110 to which the tasks belong. Each team member gets a schedule showing each of their projects 110 in a single view, with the tasks 120 that they are assigned to for each project 110 rolling up into their respective projects 110. The schedule by project view can be used to quickly scan and detect scheduling conflicts across projects 110 for a particular team member.

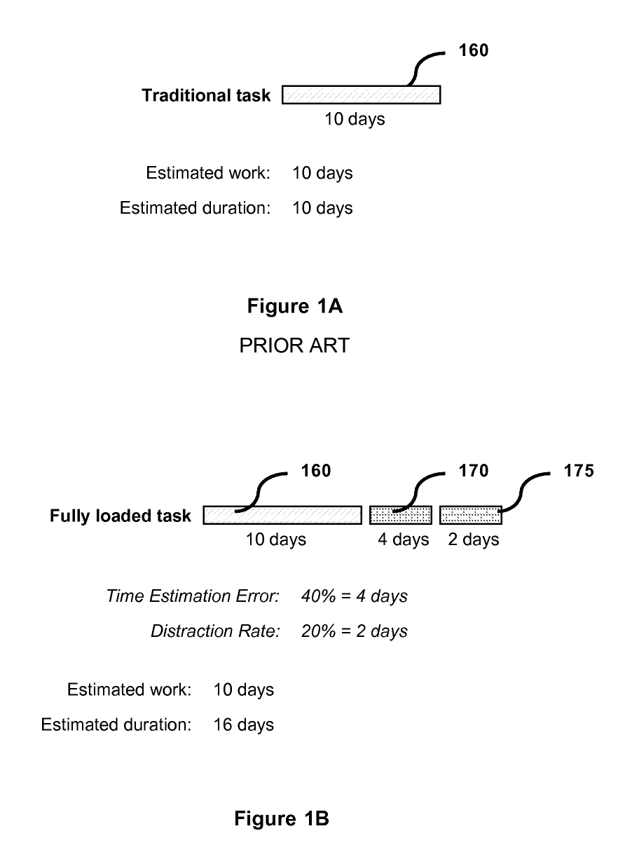

Each Gantt chart 100 can be further include not only the “estimated” duration for each task 120 on the chart, but also the effects of tracked metrics such as Time Estimation Error and Distraction Rate. FIG. 1A is a schematic representation of a traditional approach to estimating task duration in which each task is represented by its estimated duration 160. FIG. 1B is a schematic representation of an approach to estimating task duration including risk-based factors. A task that in the traditional approach shows as a duration 160 of ten days can show as sixteen days in the approach including risk-factors if, for example, there are included four days for average time estimation error 170 and two day of distractions 175 for that particular team member.

The finish date for the project, in each of the three views described above with reference to FIGS. 4, 5A and 5B, can be adjusted by quantifiable, defendable risk factors (e.g. time estimation error and distraction) as observed during a single project and across past projects, making it measurably more accurate.

### Requirement and Design Metadata on Tasks

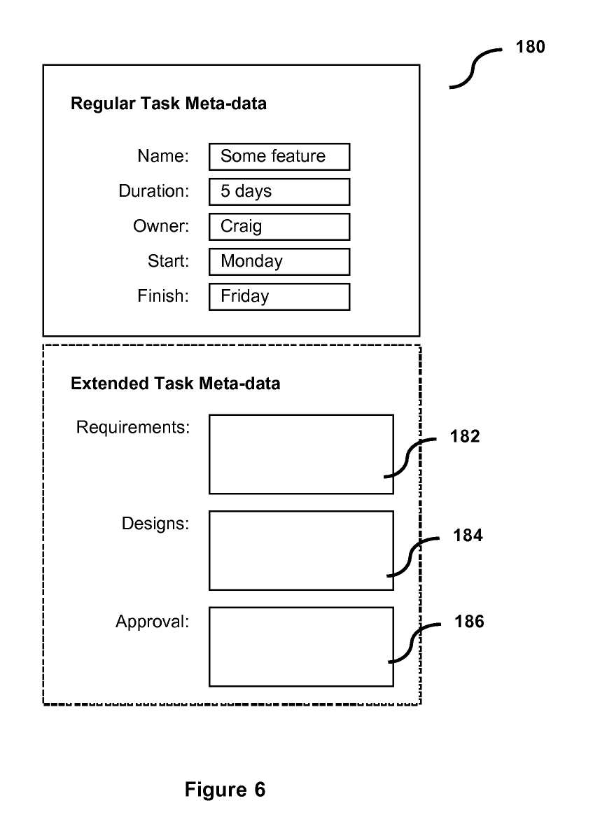

The method provides for the addition of structured metadata specific to the requirements and the designs associated with individual tasks, as well as the requirement and design approval states, and each requirement and design's metadata. FIG. 6 is a schematic representation of meta-data associated with a task in accordance with the method of the present invention.

The method provides for the structured metadata 180 for each task to describe each requirement 182 and design 184 associated with that task. For example, a task may have metadata to describe that it has three specific requirements, and two designs. Requirements may, for example, include: must support cookie-less web-browsing; must work on wireless devices; and must support screen-readers. Each requirement can have metadata 182 including, for example: name, owner, date, attachment, number of revisions, summary, and priority. Each design can have similar metadata 184.

The method provides for approval states for the task requirements and designs as well as the time estimate (i.e. duration) for each task. The approval states of each requirement, design and estimate can be represented in approval metadata 186. Each task time estimate, requirement and design can be either approved (i.e. final) or unapproved (i.e. draft). These states are used in calculating schedule confidence and are also used for workflow.

### Schedule Confidence

With the approval states of requirements, designs and time estimate (i.e. the original duration) tied to each task in the schedule, the method provides for a new metric called schedule confidence. Schedule confidence can, for example, be calculated as follows: a task starts with a score of 0%; when the requirements for the task are approved, 33% is added to the score; when the designs for the task are approved, another 33% is added to the score; and when the time estimate (i.e. the original duration) is approved, a final 33% is added to the score.

Objects that contain tasks also have a schedule confidence that is the (simple or weighted) average of schedule confidences from each of its child nodes. For example, the schedule confidence of a task-group that contains two tasks with schedule confidences of 66% and 100% respectively, is 83% (i.e. the average).

Schedule confidence can be thought of as a level of “accuracy” for the schedule, as well as an indicator of probability of the schedule being achieved on-time. It is updated every time a change is made to the status or meta-data 180 for a task and can be reported on in a real-time basis. A higher score is desirable.

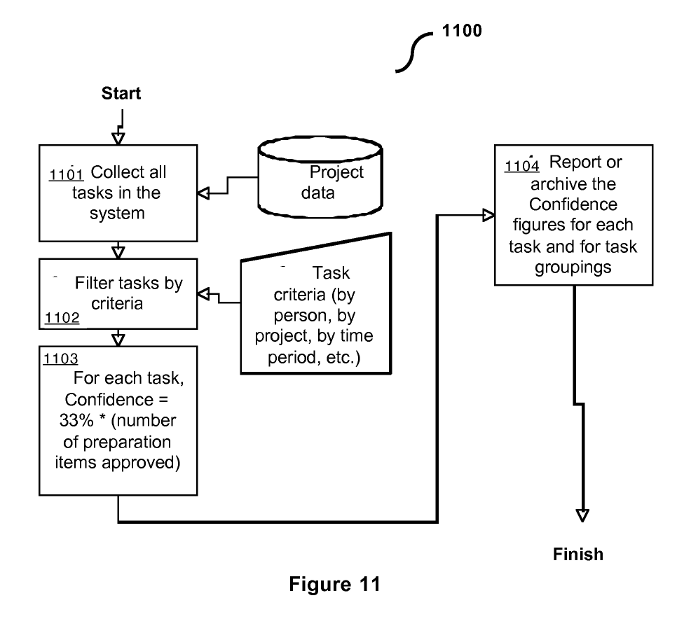

FIG. 11 is a flow diagram representing the steps 1100 for calculating schedule confidence.

In step 1101—the tasks are collected from the project store (e.g. database, file system, and 3^{rd} party system)

In step 1102—any tasks that are not to be included in the set of tasks are filtered out. If the Schedule Confidence is only being calculated for a particular team member for example, then all tasks not assigned to that team member can be filtered out.

In step 1103—for each task, the confidence score is calculated. The score is 33% times the number of (up to three) approvals required to consider the task fully approved. In this embodiment, those approvals are for: requirements, designs and time estimate.

In step 1104—the score is archived for future use and/or the score is reported directly.

### Time Estimation Error

The method provides for a process for managing and improving inaccurate time estimates that are given by team members, both during an individual project and iteratively with subsequent projects performed by the same team members or organization.

A time estimation error index is a percentage value and is the measure of the average overrun or under-run of time estimates given for the tasks included in a set. For an individual task, the original estimate is compared with the actual duration and a net error margin is calculated. For example, a task that was estimated to take 10 days, but actually took 14 days, the Time Estimation Error is 40%.

Time estimation error can be averaged (simple or weighted), alternatively, for team members, task-groups, projects, and over time.

Applications for time estimation error can, for example, include:
Informing individual time estimates for new tasks assigned to the same team member: Once a historical baseline for time estimation error for an individual has been calculated, it may be used by the team member or the team member's supervisor to inform new estimates given by that team member. If a team member believes that a new task will take five days but knows that his/her time estimation error is 20%, he/she can modify the estimate from five to six days, thus improving the chances of success in accurately estimating new tasks. With more sample data feeding the metrics, the ratio becomes more accurate over time;
Building time into the schedule for error: Once time estimation error metrics are known, they can be manually (e.g. according to a process) or automatically (e.g. using a tool) embedded in a project schedule to balance risk. If the team's average time estimation error on tasks is 25%, there is a good statistical chance that a four month project could actually take up to five months; and
Time estimation error can be used to match coaches with troubled team members, to share knowledge on how to improve time estimation techniques.

Time estimation error from past projects can be pulled forward to improve estimates or mitigate the effects on future schedules.

Time estimation error can optionally be included in the Gantt chart in any of the embodiments of the method described herein.

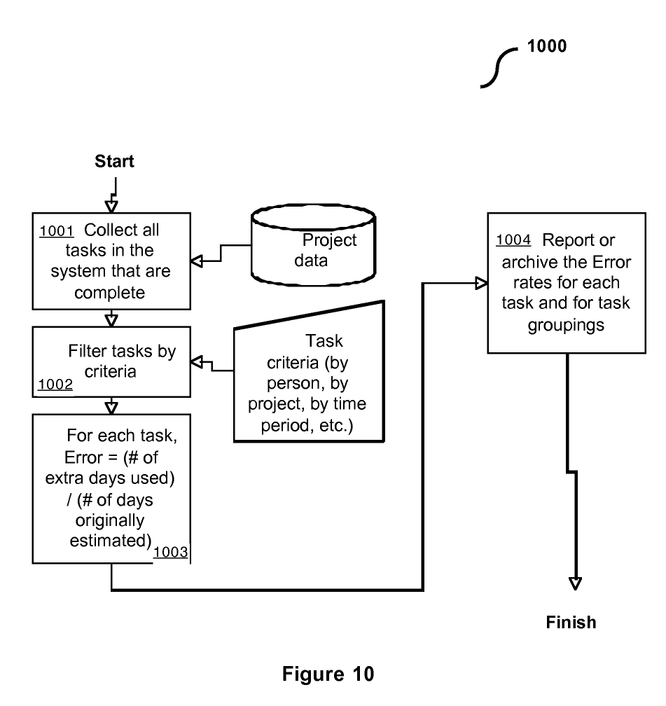

FIG. 10 is a flow diagram representing the steps 1000 for calculating time estimation error.

In step 1001—the tasks are collected from the project store (e.g. database, file system, and 3^{rd} party system)

In step 1002—any tasks that are not to be included in the set of tasks are filtered out. When, for example, the time estimation error is only being calculated for a particular period of time then all tasks not performed during that period can be filtered out.

In step 1003—for each task, the time estimation error is calculated. The score (i.e. time estimate error) is calculated as follows: First, count the number of extra days used (=actual duration−estimated duration, in working days). Next, divide the number of extra days used by the number of days originally estimated. For example, if an original estimate was 10 days, but the actual duration was 13 days, the Time Estimation Error is 30%.

In step 1004—the score is archived for future use and/or the score is reported directly.

### Distraction Rates

The method provides for a process for managing and scheduling around distractions that come up during a project, thus serving to reduce the impact of those distractions on the finish date of the project. A distraction is defined as a task or period of work time that is not directly related to the project. Distractions are known by being explicitly flagged as a distraction by someone on the project team or by being a period of time a team member is booked on another project. The distraction rate can be expressed as a percentage value. The distraction rate is calculated by adding up the time a team member spends doing activities unrelated to the project, and dividing that by the amount of time in a period. For example, a team member that spends five days in a month away from a project would have a distraction rate of 25% (i.e. five out of twenty working days).

Applications for the distraction rate can, for example, include:
Forecasting a team member's availability: If it was known that a team member's distraction rate was 25%, teams would know to schedule that team member over five months for every four months of work they needed from that person, based on historical evidence;
Managers can use distraction rates as a measure of productivity on their projects, related to other projects their team members may be working on; and
Managers can use distraction rates as a check against relative priority of their projects. If a project is supposed to be a #1 priority to the organization, but the average distraction rate for the team is 40%, something is clearly (and quantifiably) wrong.

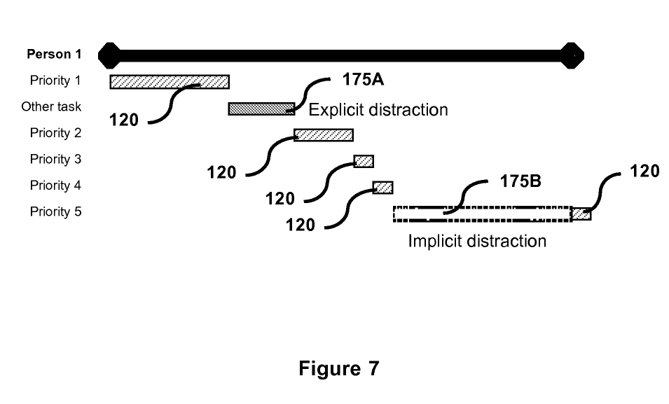

FIG. 7 is a schematic representation of tasks 120 illustrating both explicit 175A and implicit 175B distractions. Distractions can be explicit 175A (e.g. any task that is manually flagged as a distraction), or implicit 175B (e.g. any time a team member spends on another project).

Distraction rates can optionally be shown directly on the Gantt chart in any of the embodiments of the method described herein.

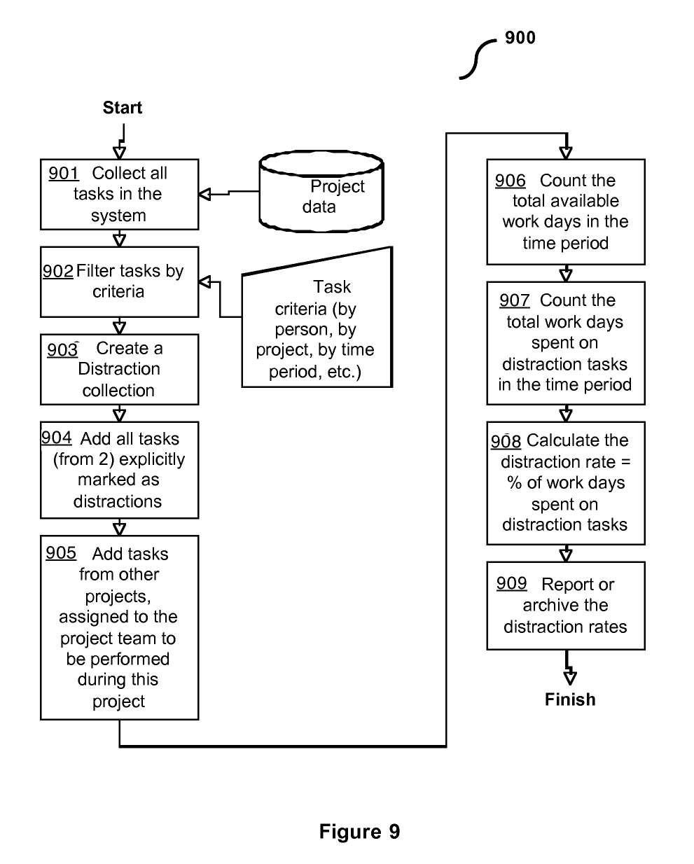

FIG. 9 is a flow diagram representing the steps 900 for calculating distraction rate.

In step 901—the tasks are collected from the project store (e.g. database, file system, and 3^{rd} party system)

In step 902—any tasks that are not to be included in the set of tasks are filtered out. When, for example, the distraction rate is only being calculated for a particular team member over a particular month, then all tasks not performed during that period (by that team member) can be filtered out.

In step 903—a new collection of tasks is created (i.e. the distraction collection).

In step 904—the tasks not filtered out by step 902 that are also explicitly flagged as distractions (e.g. their meta-data indicates they are explicit distractions) are added to the distraction collection.

In step 905—Add any tasks from other projects during the same period of time, that are also assigned to the team member(s) for which the distraction rate is being calculated (these are called implicit distractions).

In step 906—the total number of available work days in the time period for all of the team members included in the scope of the calculation are counted. For example, when the distraction rate is being calculated for the month of June, for four team members, and there are twenty working days in June, the total # of available working days is 4*20=80 days.

In step 907—the total number of working days spent on tasks that are considered distractions (implicit or explicit) by the appropriate team members are counted. For example, if only one team member spent five days working on a task for another project during the month of June (as in step 906), then his/her distraction time is five days.

In step 908—the distraction rate is calculated as follows: Divide the total number of distraction days by the total number of available work days, for the team members and time period that defines the scope of this calculation. For example, if two of four team members each spent ten days working on an implicit or explicit distraction in the month of June, the Distraction Rate for the group is 20/80=25%.

In step 909—the score is archived for future use and/or the score is reported directly.

### Risk Based Scheduling

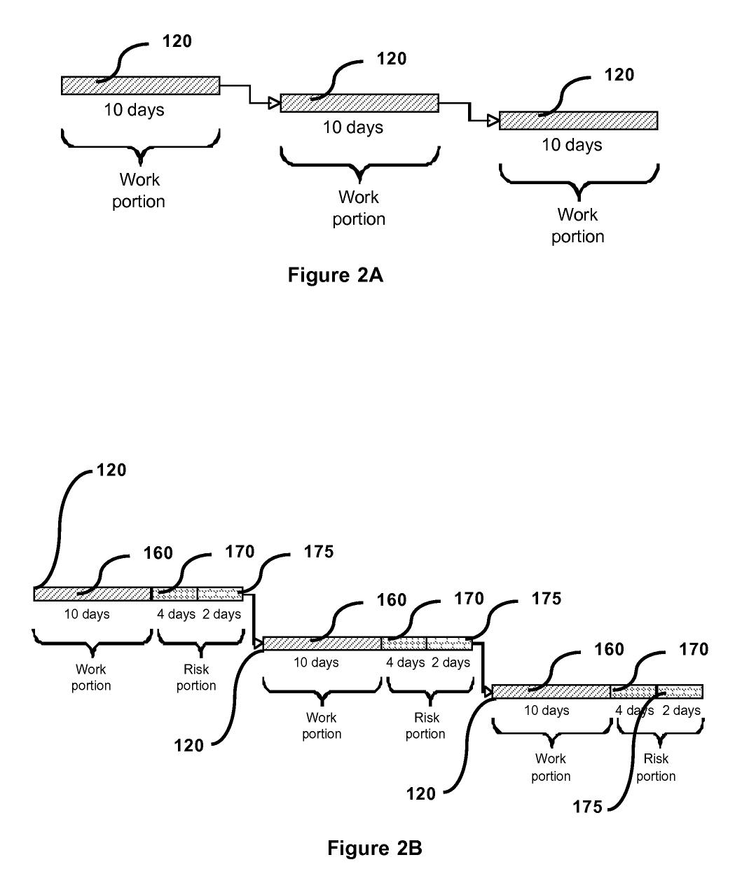

Schedules are typically built by serializing a set of tasks for each member of the team. FIG. 2A that is a schematic representation of a traditional approach to scheduling sequential tasks 120 based on the estimated task durations 160. The project finishes when the last (chronological) task 120 is complete.

The method provides for specifically marking-up time estimates 160 with statistically observed factors such as time estimation error 170 and distraction rates 175, to arrive at an adjusted time estimate. FIG. 2B is a schematic representation of an approach to scheduling sequential tasks 120 including risk-based factors 170, 175 in accordance with a method of the present invention.

The method provides for arriving at a project schedule by serializing the tasks 120 chronologically including the statistically observed factors such as time estimation error 170 and distraction rates 175, to arrive at a risk-balanced schedule (i.e. a schedule that takes into consideration historical trends).

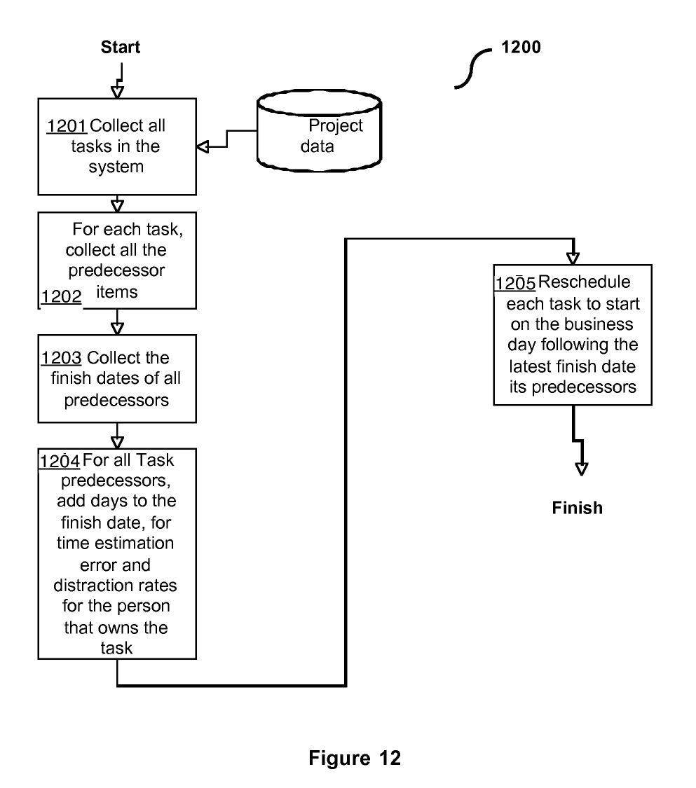

FIG. 12 is a flow diagram representing the steps 1200 for risk based scheduling.

In step 1201—the tasks are collected from the project store (e.g. database, file system, and 3^{rd} party system).

In step 1202—for each task, the predecessor tasks (a predecessor task is one that must finish first, according to dependencies that exist) are collected.

In step 1203—for each predecessor task, all of its predecessors are also added (this is a recursive function).

In step 1204—for each predecessor now collected, a number of days are added to the finish date that equals the sum of days allocated for risk. The number of days allocated for risk (in this embodiment) includes the distraction rate and time estimation error rates for the team member the task is assigned to.

In step 1205—each task in the project is rescheduled to start on the following business day after the latest finish date in the collection of its predecessors (after their finish date has been adjusted for risk).

### Source Data Inputs

Source data to be used in the method for project management can be enter in a variety of approaches including, for example:
The source data is entered manually by end-users;
The source data is collected from a local data store (e.g. a database or a file system) where the data had been previously collected and stored; and
The source data is collected via an application program interface (API).

### Source Data Types

Source data required used by can, for example, include:
Task data including, for example: start date; finish date; duration; % complete
Team member data including, for example: name; which tasks are assigned to
Dependencies including, for example: references to which tasks are to be dependent on which other tasks
Requirements and designs including, for example: descriptions of the various requirement and designs that are to be stored with each task
Distractions including, for example: flags on each task describing whether or not a task is an explicit distraction

### Generated Data

The method can generate data by processing the input data and observing changes to the input data. The generated data can, for example, include:
For each task—the original time estimate (duration), revised time estimates and the actual duration; an indication of whether or not a task is an implicit distraction; time estimation error for the task; distraction rate for the task; confidence score for the task based on what combination of requirements, designs and time estimate are approved
Implicit dependencies—by looking at the related objects for each task (who it is assigned to, what task group it belongs to), dependencies are automatically generated and managed
For each team member—aggregate time estimation error, distraction rate and confidence metrics
For the project—aggregate time estimation error, distraction rate and confidence metrics

### Data Storage

Data generated by the method can, for example, be stored in a file system or database, with proprietary formats or alternatively open extensible formats.

The method according to the present invention can be performed manually or automatically using, for example, a computing platform based implementation.

The method according to the present invention can be implemented by a computer program product comprising computer executable program instructions stored on a computer-readable storage medium.

The method according to the present invention can be applied to the management of software development projects or alternatively to the management of other managed projects.

It will be apparent to one skilled in the art that numerous modifications and departures from the specific embodiments described herein may be made without departing from the spirit and scope of the present invention.

1. A method for project management by adding risk-based adjustments to a schedule for a project, the project having a plurality of tasks, each task having an estimated duration and one or more dependencies on other tasks, the project further having one of a plurality of team members assigned for executing each of the tasks and a project store for storing the task estimated duration, dependency and team member information for each task, the method comprising the steps of:
collecting all of the tasks in the project;
collecting, for each task, all of the predecessor tasks from which the task has a dependency;
adding to the collected predecessor tasks, for each predecessor task, any other predecessor tasks from which the predecessor task has dependencies until all predecessor tasks have been collected;
adding a risk-based adjustment to the finish date of each of the collected predecessor tasks, the risk-based adjustment comprising:
a distraction rate for the team member assigned to predecessor task; and
a time estimation error rate for the team member assigned to the predecessor task; and
rescheduling each of the tasks in the project to start on the business day after the latest finish date of any of the predecessor tasks of the task.

2. The method of claim 1, further comprising the step of calculating a distraction rate for a time period, the step of calculating comprising the steps of:
collecting all tasks in the project store;
filtering the tasks responsive to criteria including any one of: a team member, a project and a time period;
creating a distraction collection;
adding to the distraction collection all tasks, not removed in the step of filtering, having meta-data indicating that the task is an explicit distraction;
adding to the distraction collection all tasks, not removed in the step of filtering, associated with other projects occurring during the period and that are assigned to a team member who is also assigned to at least one task in the project and indicate that the task is an implicit distraction in the meta-data of the task;
count a total number of working days available in the period for all of the team members who are assigned to at least one task in the project;
count the total number of distraction days by counting the estimated durations, in working days in the period, for all tasks having meta-data indicating that they any of: explicit distractions and implicit distractions; and
calculate the distraction rate by dividing the total number of distraction days by the total number of available working days in the period for all team members who are assigned to at least one task in the project,

3. The method of claim 1, further comprising the step of calculating time estimation errors, the step of calculating comprising the steps of:
collecting all tasks in the project store that are complete;
filtering the tasks responsive to criteria including any one of: a team member, a project and a time period;
calculating, for each task, a time estimation error by dividing the number of working days needed to complete the task that exceeded an estimated duration for task by the estimated duration for task; and
archiving the calculated time estimation error for each task.

4. The method of claim 1, further comprising the step of calculating schedule confidences, the step of calculating comprising the steps of:
collecting all tasks in the project store;
filtering the tasks responsive to criteria including any one of: a team member, a project and a time period;
calculating, for each task, a schedule confidence by multiplying 33% by a number of approved preparation items for the task; and
archiving the calculated schedule confidence for each task;
wherein the preparation items include: requirement, design and time estimate.

5. The method of claim 1, further comprising the step of detecting and recording circular references when making a first task dependent on a second task, the step of detecting and recording comprising the steps of:
collecting all tasks in the project store on which the second task has a dependency and adding the tasks to a pre-requisite collection;
adding to the pre-requisite collection, for all tasks in the pre-requisite collection, all tasks on which the task in the pre-requisite collection has a dependency;
creating a schedule assertion between the first task and each of the tasks in the pre-requisite collection;
testing each of the schedule assertions and capturing any resulting conflicts;
archiving the conflicts captured in the step of testing;
disallowing the making of the first task dependent on a second task when any conflicts were captured in the step of testing; and
allowing the making of the first task dependent on a second task when no conflicts were captured in the step of testing.

6. The method of claim 1, further comprising the step of presenting the rescheduled tasks in the form of a Gantt chart presenting, for each task, the estimate duration, time estimation error and a production of the distraction rate and the estimation duration.

7. The method of claim 6, wherein the Gantt chart presents the tasks organized by one of: component, team member and project; and wherein the Gantt chart organized by component presents the tasks grouped by task-group for a single project; the Gantt chart organized by team member presents the tasks grouped by team member for a single project; and the Gantt chart organized by project presents the tasks grouped by team member to whom the tasks are assigned for one or more projects.
